(19) United States
(12) Patent Application Publication
(10) Pub. No.: US 2012/0176714 A1
(43) Pub. Date: Jul. 12, 2012

(54) ELECTRIC SHOCK PROTECTION DEVICE

(75) Inventor: Ching-Chi Cheng, New Taipei City (TW)

(73) Assignee: ADVANCED-CONNECTEK INC., Taipei (TW)

(21) Appl. No.: 13/313,543

(22) Filed: Dec. 7, 2011

(30) Foreign Application Priority Data
Jan. 10, 2011 (TW) 100100872

(51) Int. Cl. H02H 3/20

(52) U.S. Cl. 361/86

(57) ABSTRACT

An electric shock protection device is provided, including a voltage input unit, a rectifier unit, a determine unit, an output control unit and a switch unit. The voltage input unit receives an AC voltage, and the rectifier unit rectifies the AC voltage to time-varying DC voltage. The determining unit determines whether the time-varying DC voltage is less than or greater than the preset voltage and selectively chooses an output control signal to determine whether there is an external receptor connected in series with the input power. The output control unit is driven by the control signal to make the switch unit control whether the time-varying DC voltage is provided to the electrical load, and to sustain or interrupt the conductive circuit loop. Accordingly, the receptor can be avoided from being subjected to an electric shock from high AC voltage.

### FIELD OF THE INVENTION

The present invention relates to an electric shock protection device, and in particular to an electronic device that can prevent electric devices from forming a conductive circuit through the human body (or the receptor) and causing an electric shock to the human body (or the receptor).

### BACKGROUND OF THE INVENTION

Among the prior arts, an electronic device rectifies alternate current (AC) voltage to direct current (DC) voltage through a rectifier to provide power to the electronic device. However, when the electronic device is in contact with only one of the AC power ends, the user may inadvertently touch the other AC power end of the power input and a conductive circuit is formed though the user and the power end. In this case, if the AC generated by the AC power end is in low voltage, human body is not possibly subjected to electric shocks due to the high resistance of the human body. On the other hand, if the AC generated by the AC power end is in high voltage, the inner resistance of the human body decreases as the voltage increases, and the user would be subjected to electric shock due to the high AC voltage.

Therefore, this invention provides an electric shock protection device combined with an internal rectifier of the electric device to prevent users from suffering the risk of electric shock by forming a conductive circuit loop with the electronic device.

### SUMMARY OF THE INVENTION

An objective of this invention is to provide an electric shock protection device detecting whether the input power is connected with the receptor to determine whether to provide power to the electrical load in order to avoid the receptor from being subjected to an electric shock.

To achieve the goal mentioned above, this invention provides an electric shock protection device which is connected with an electrical load. The electric shock protection device includes a voltage input unit, a rectifier unit, a determining unit, a output control unit, and a switch unit. Among them, the voltage input unit is an external AC power source, and the rectifier unit is connected with the voltage input unit to rectify the AC voltage to time-varying DC voltage. The determining unit is connected with the rectifier unit and, when the input voltage of the determining unit is less than 36V, the determining unit cannot use a result of whether the electrical load is provided with enough rated current through an external receptor to determine whether the input voltage is connected in series with the external receptor. The output control unit is connected with the determining unit to decide whether to provide a control signal to the output control unit according to the result of the determining unit. The switch unit is connected to the output control unit to and the switch unit is controlled by the output control unit to either sustain or interrupt a conductive circuit loop of the electrical load.

Compared with the prior arts, this invention provides an electric shock protection device that operates under a safe voltage range which is less than 36V to determine whether there is contact of human body so as to avoid human body from getting hurt during the determination, and then, according to the result of the determination, decide whether to provide power to the electrical load in order to prevent the human body from being in series with the electrical load and electrified, thus avoiding the risk of electric shock subjected to the human body. Therefore, the present invention can be provided to electronic products with power rectifiers for the purpose of preventing users from suffering the hazardous electric shock by merely inadvertently touching the single power input end of electronic products. In other words, the human body would be prevented from concerns of exposure to electric shock by being connected in series with the electrical load.

### BRIEF DESCRIPTION OF THE DRAWINGS

FIG. 1 is a block diagram of an embodiment of an electric shock protection device;

FIG. 2 is a detailed circuit diagram of an embodiment of the electric shock protection device; and

FIG. 3 is detailed circuit diagram of another embodiment of the electric shock protection device.

### DETAILED DESCRIPTION OF THE INVENTION

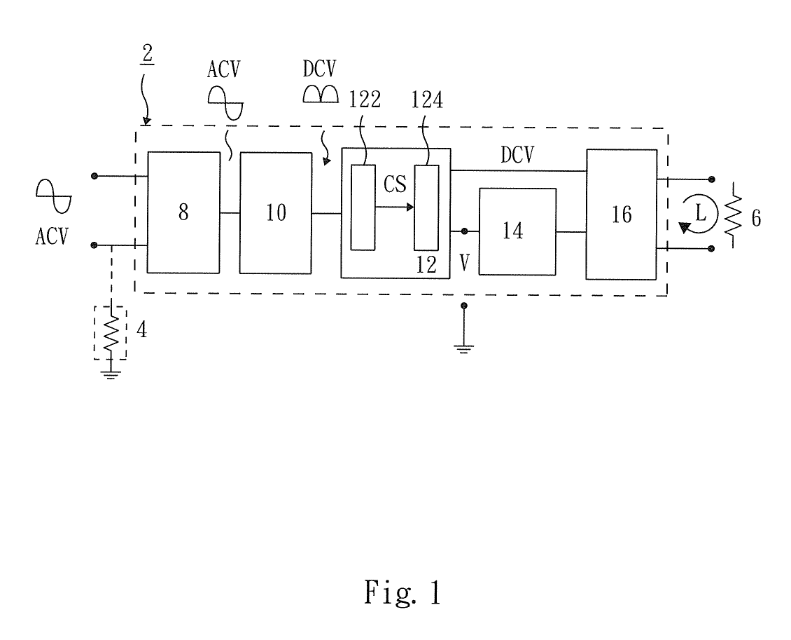

In order to reach understanding of the goals, characteristics, and functions of this invention, the following embodiments and examples are revealed with the reference to figures to explain the concept of the invention specifically in detail. Firstly, referring to the FIG. 1, which is a block diagram of an embodiment of an electric shock protection device. The figure shows that the electric shock protection device (2), which is connected with an electrical load (6), includes a voltage input unit (8), a rectifier unit (10), a determining unit (12), an output control unit (14), and a switch unit (16).

The voltage input unit (8) receives an external AC voltage (ACV), which can be from a commercial electric company. In other words, the ACV provides a sine signal wave signal with a half positive and half negative period.

The rectifier (10) is connected with the voltage input unit (8). The conductive circuit loop is formed so that the ACV is rectified through the rectifier unit (10) to a time-varying DC voltage (DCV). Furthermore, the rectifier unit (10) rectifies either half wave or entire wave. The one rectifies the entire wave is a bridge rectifier.

The determining unit (12) is connected with the rectifier unit (10) to determine whether the electric shock protection device (2) is connected in series with a receptor (4). In this embodiment, the receptor is human body. Under general circumstances, when the human body contacts with a power end and a ground end, the conductivity condition of human body is affected by the power voltage value of the power end. When contacting with a low voltage, the human body is highly resistant or insulated. On the contrary, if staying at a high voltage, the human body would be lowly resistant or conductive. Therefore, the conductivity of human body is related to the power voltage value.

In this embodiment, the electric shock protection device (2) forms a conductive circuit loop because the receptor (4) is connected to the ground. In other words, the change exists where the ACV is high and thus the receptor (4) is lowly resistant. The high voltage transmits to the receptor (4), resulting in the receptor (4) being electrified. In contrast, when the ACV is low, the receptor (4) is highly resistant so as not to be easily electrified. The way the determining unit (12) determines whether the receptors (4) is connected in series is described as follows.

When the determining unit (12) receives the DCV, the determining unit (12) determines whether the DCV is greater than a preset voltage (PV) in order to determine an output control signal (CS). The preset voltage can be preferably set as 36V. Generally, when the input voltage for the determining unit (12) is less than 36V, it is determined as the current passing through the external receptor (4) to form a conductive circuit loop. Therefore, the determining unit (12) can determine whether the input power is connected in series with an external receptor (4) according to the provision of rated current to the electrical load (6).

In a further embodiment, the determining unit (12) further includes a voltage comparator (122) and a first switch (124), and the determining unit (12) is connected with the rectifier unit (10). The voltage comparator (122) generates a corresponding CS according to the DCV. The CS determines whether the first switch (124) is open (conductive) or closed (cutoff), resulting in the first switch (124) forming an open circuit or a short circuit. It should be noted that the voltage comparator (122) operates reversely to the first switch (124). In other words, when the voltage comparator (122) is conductive, the first switch (124) operates as an open circuit. Conversely, while the voltage comparator (122) is cutoff, the first switch (124) operates as a short circuit. In an embodiment, the first switch (124) can be any one of a junction transistor (BJT), a field effect transistor (FET), and a metal-oxide-semiconductor field-effect transistor (MOSFET).

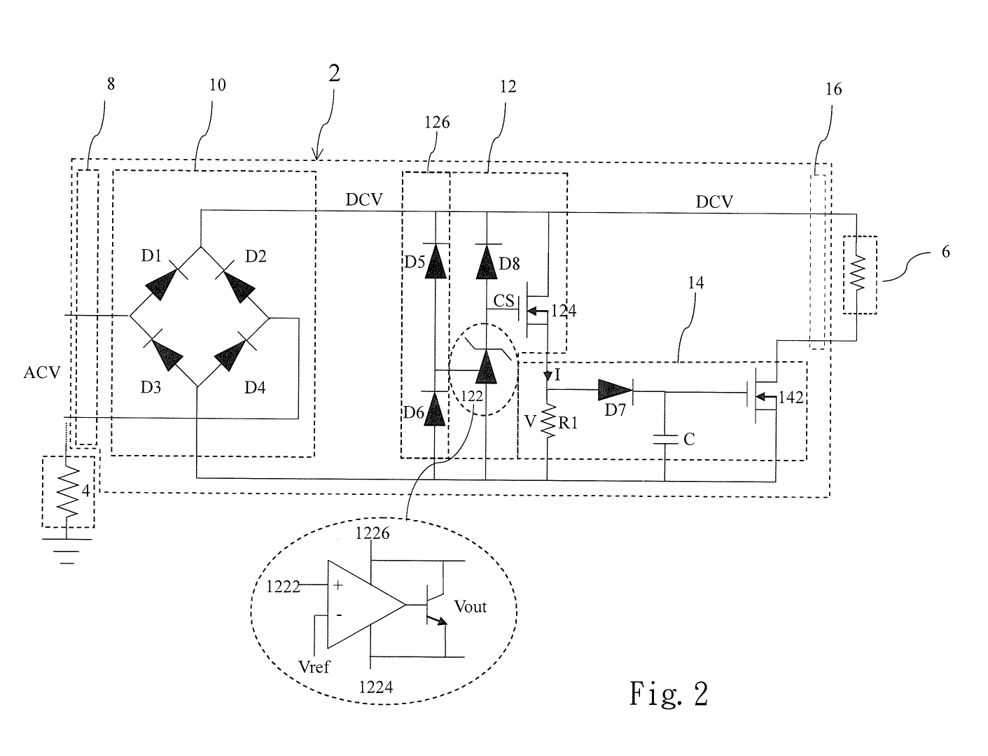

The output control unit (14) is connected with the determining unit (12) to determine whether to provide the DCV to the output control unit (14) according to the result of the determining unit (12). The output control unit (14) is connected with one of an output end of the first switch (124) of the determining unit (12). In other words, the output control unit (14) controls the switch unit (16) according to the voltage value V generated by the current passing through the first switch (124). In an embodiment, the output control unit (14) can further comprise at least one of an input resistor, a diode, a capacitor, and a second switch. The second switch (124) can be any one of the BJT, FET, and MOSFET. That is, using MOSFET as an example, as shown in FIG. 2, the output control unit (14) is connected to the source or the drain of the MOSFET, and the gate controls the conductive condition between the source and the drain.

The switch unit (16) is connected in between the output control unit (14) and the electrical load (6). The switch unit (16) determines whether to maintain or interrupt the conductive circuit loop between the electrical load according to the CS. In other words, when the output control unit (14) is conductive, the switch unit (16) forms a conductive circuit loop L through the electrical load (6). Conversely, when the output control unit (14) is cutoff, the DCV cannot be provided to the electrical load (6) to form a conductive circuit loop L. That is, when the input ACV is high and greater than PV, the first switch (124) and the second switch (142) are cutoff simultaneously. If the input ACV increases from low to high voltage, the first switch (124) is conductive. Then the second switch (142) is selectively conductive by the DCV to maintain or interrupt the conductive circuit loop by determining whether the receptor (4) is connected. On the other hand, maintaining the conductive circuit loop means the second switch (142) is conductive, and interrupting the conductive circuit loop represents the second switch (142) being an open circuit.

In another embodiment, the determining unit (12) further includes a divider circuit (126) which divides the DCV and provides divided DCV to the voltage comparator (122) as shown in FIG. 2. The divider circuit (126) comprises a power supply and a resistor connected in series, or resistors connected in series. The voltage comparator (122) further includes a reference voltage end (1222), a positive pole (1224), and a negative pole (1226). The reference voltage end (1222) is set to Vref (or the preset voltage, PV) according to the divided DCV. In other words, the voltage comparator (122) is set to Vref so that the reference voltage Vref is reached between the positive pole (1224) and the negative pole (1226). The voltage comparator (122) provides a stable voltage output in order to generate the CS that conducts the first switch (124). It should be noted that the voltage comparator (122) and the first switch (124) controls reversely. When the voltage comparator (122) does not reach the Vref, the voltage comparator (122) is cutoff. On the other hand, when the voltage comparator (122) reaches the Vref, the voltage comparator (122) is conducted. The voltage comparator (122) can be a TL 341 or a Zener Diode.

Referring to FIG. 2 which is a detailed circuit diagram of an embodiment of the electric shock protection device. This figure shows that the electric shock protection device (2) is connects with the electrical load (6) in order to avoid the receptor (4) from being subjected to electric shock due to high ACV. The electric shock protection device (2) includes a voltage input unit (8), a rectifier unit (10), a determining unit (12), and a switch unit (16).

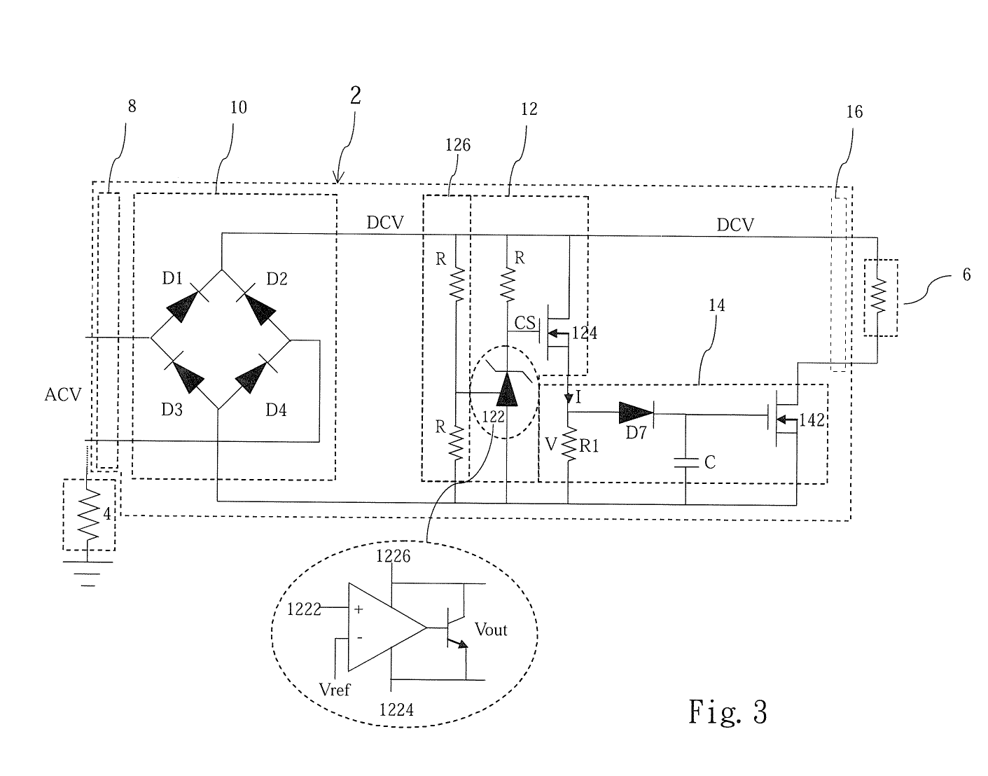

In this embodiment, the rectifier unit (10) is a full-wave bridge rectifier comprising four diodes (D1-D4). When the rectifier unit (10) receives the ACV from the voltage input unit (8), the rectifier unit (10) obtains a full-wave DCV. The determining unit (12) includes a voltage comparator (122), a first switch (124), and a divider circuit (126). In this embodiment, the TL 341 is utilized as the voltage comparator (122) for example. In another embodiment, the voltage comparator (122) can be a Zener Diode or any equivalent circuit such as an operational amplifier. Furthermore, in this embodiment, MOSFET is utilized as the first switch (124) for example, and the first switch (124) can be substituted by a BJT or a FET. The divider circuits (126) are diodes (D5 and D6 respectively). In another embodiment, the diodes can be substituted by a power supply and a resistor, or a plurality of resistors. For example, in FIG. 3, the resistors replace the diodes. The output control unit (14) includes an input resistor (R1), a diode (D7), a capacitor (C) and a second switch (142).

The divider circuits (126) provides the TL 341 a reference voltage (1222) to set up the output voltage (Vout). The negative pole (1226) of the TL 341 is connected to a diode (D8) and also to the gate of the first switch (124). In another embodiment, the diode (D8) can be substituted by a resistor or a power supply. Furthermore, the TL 341 generates CS to the gate according to the condition of TL 314 in order to control the conductivity between the drain and the source of the first switch (124). The interior of the TL 341 is equipped with a base voltage of 2.5V, and the TL 314 can attain a very wide range of bypass from the negative pole (1226) to the positive pole (1224). Generally, the range of the output voltage of the TL 314 varies from 2.5V to 36V according to different values of D5 and D6. In other words, when the equivalent resistances R2 and R3 of D5 and D6 are determined, the corresponding voltage can be expressed as Vout=(1+R2/R3) Vref.

When the drain and the source are conducted according to the CS, the current I of DCV passes through the drain and the source to the input resistor R1 and generates a corresponding voltage V. Furthermore, the diode (D7) connected with the input resistor (R1) has a barrier voltage which is about 0.2V to 0.8V. When the voltage V is greater than the barrier voltage, the diode (D7) is conducted to the gate of the second switch (142). In contrast, the diode (D7) is not conductive. In this embodiment, the voltage V minus the barrier voltage is sufficient to charge the capacitor (C) and control the conductivity of the second switch (142). It should be noted that the equivalent capacitance of the diode (D7) and the gate can further include a parasitic capacitance existed between the capacitor (C) and the gate or the source. The voltage of the gate can be used to determine the conductivity between the drain and the source. The conductivity between the drain and the source can further determine the switch unit (16) whether the DCV is provided to the electrical load (6). In other words, when conductivity exists between the drain and the source, the electrical load (6) is provided with the DCV.

On the other hand, if the receptor (4) is in contact with the device, the low inner resistance of the receptor (4) decreases the current I of the DCV passing through the input resistance (R1). The R1 generated by V is not sufficient to conduct the diode (D7) so that the drain and the source of the second switch (142) are not conductive, resulting in no DCV flowing through the electrical load (6). In other words, the electric shock effect of the electrical load (6) on the receptor (4) does not exist any more to prevent the receptor (4) from being subjected to electric shock.

Compared with the prior arts, this invention provides an electric shock protection device that operates under a safe voltage range which is less than 36V to detect whether there is contact of the human body so as to avoid the human body from being hurt and then decide by the result whether to provide power to the electrical load in order to avoid the risk of electric shock subjected to the human body due to the human body being connected in series with the electrical load. Therefore, the present invention provides electronic products with power rectifiers for the purpose of preventing users from suffering the hazardous electric shock by merely inadvertently touching the single power input end of electronic products. In other words, the human body would be prevented from concerns of exposure to electric shock by being connected in series with the electrical load.

The preferred embodiments of the present invention have been disclosed in the examples. However the examples should not be constructed as a limitation on the actual applicable scope of the invention, and as such, all modifications and alterations without departing from the spirits of the invention and appended claims shall remain within the protected scope and claims of the invention.

What is claimed is:

1. An electric shock protection device connected with an electrical load, the electric shock protection device comprising:
a voltage input unit receiving an external AC voltage;
a rectifier unit connected with the voltage input unit to rectify the AC voltage to a time-varying DC voltage;
a determining unit connected with the rectifier unit to receive the time-varying DC voltage and determine whether the time-varying DC voltage is greater than a preset voltage to choose a control signal for output;
an output control unit connected with the determining unit to receive the control signal; and
a switch unit connected between the output control unit and the electrical load to sustain or interrupt a conductive circuit of the electrical load according to the control signal.

2. The electric shock protection device according to claim 1, wherein the determining unit further comprises a first switch and a voltage comparator, the voltage comparator comparing between the time-varying DC voltage and the preset voltage to produce the control signal for the first switch to form open circuit or short circuit according to the control signal.

3. The electric shock protection device according to claim 2, wherein the determining unit further comprises a voltage divider circuit to divide the time-varying DC voltage for providing divided time-varying DC voltage to the voltage comparator.

4. The electric shock protection device according to claim 3, wherein the voltage divider circuit comprises a current source and a resistor connected in series, or resistors connected in series.

5. The electric shock protection device according to claim 3, wherein the voltage comparator further comprises a positive pole, a negative pole, and a reference voltage end, the reference voltage end determining the reference voltage according to the divided time-varying DC voltage.

6. The electric shock protection device according to claim 5, wherein the voltage comparator operates reversely with the first switch.

7. The electric shock protection device according to claim 6, wherein the voltage comparator is a TL 341 or a Zener diode.

8. The electric shock protection device according to claim 1, wherein the output control unit further comprises at least one of an input resistor, a diode, a capacitor, and a second switch.

9. The electric shock protection device according to claim 8, wherein the first switch and the second switch are selected from one of a bipolar junction transistor (BJT), a field-effect transistor (FET) and a metal-oxide-semiconductor field-effect transistor (MOSFET).

10. The electric shock protection device according to claim 1, wherein the rectifier unit is a bridge rectifier.
